(19) United States
(12) Patent Application Publication
(10) Pub. No.: US 2026/0070273 A1
(43) Pub. Date: Mar. 12, 2026

(54) RUNNER REMOVING METHOD AND INJECTION MOLDING DEVICE

(71) Applicant: SEIKO EPSON CORPORATION, Tokyo (JP)

(72) Inventor: Masayuki SAKAI, MATSUMOTO-SHI (JP)

(21) Appl. No.: 19/322,932

(22) Filed: Sep. 9, 2025

(30) Foreign Application Priority Data
Sep. 12, 2024 (JP) 2024-158030

(51) Int. Cl. B29C 45/38

(52) U.S. Cl. CPC B29C 45/38

(57) ABSTRACT

A runner removing method of removing a runner in a molding die that includes a first plate including a stripper plate, a second plate, and a third plate/ A cavity is defined between the second plate and the third plate. The method includes, after a molded article is molded in the cavity in a state where the first plate, the second plate, and the third plate are closed, separating the second third plates from the first plate in a state where the runner is attached to the first plate, inserting, between the first and second plates that are spaced apart, a guide section including a pair of wall sections, and positioning the runner between the pair of wall sections, and, in a state where the runner is positioned between the pair of wall sections, operating the stripper plate to detach the runner from the molding die.

The present application is based on, and claims priority from JP Application Serial Number 2024-158030, filed September 12, 2024, the disclosure of which is hereby incorporated by reference herein in its entirety.

### BACKGROUND

### 1. Technical Field

The present disclosure relates to a runner removing method and an injection molding device.

### 2. Related Art

JP-A-5-192968 discloses a technique of using a chuck to pull out and discharge a runner remaining in a molding die.

In the related art, since the chuck is used to remove the runner, the form of the chuck needs to be changed depending on the shape of the runner in some cases. Therefore, a technique capable of easily discharging the runner without using a chuck is desirable.

### SUMMARY

According to a first aspect of the present disclosure, a runner removing method of removing a runner in a molding die that includes a first plate including a stripper plate, a second plate, and a third plate and in which a cavity is defined between the second plate and the third plate is provided.

The runner removing method includes (A) a step of, after a molded article is molded in the cavity in a state where the first plate, the second plate, and the third plate are closed, separating the second plate and the third plate from the first plate in a state where the runner is attached to the first plate; (B) a step of inserting, between the first plate and the second plate that are spaced apart, a guide section including a pair of wall sections, and of positioning the runner between the pair of wall sections; and (C) a step of, in a state where the runner is positioned between the pair of wall sections, operating the stripper plate to detach the runner from the molding die.

According to a second aspect of the present disclosure, an injection molding device is provided.

The injection molding device includes a molding die clamping device to which a molding die that includes a first plate including a stripper plate, a second plate, and a third plate and in which a cavity is defined between the second plate and the third plate is mounted; a guide section including a pair of wall sections; and a control section that controls operations of the molding die and the guide section, wherein after a molded article is molded in the cavity in a state where the first plate, the second plate, and the third plate are closed, the control section separates the second plate and the third plate from the first plate in a state where a runner is attached to the first plate, inserts the guide section between the first plate and the second plate that are spaced apart, positions the runner between the pair of wall sections, and, in a state where the runner is positioned between the pair of wall sections, operates the stripper plate to detach the runner from the molding die.

### BRIEF DESCRIPTION OF THE DRAWINGS

FIG. 1 is a perspective view showing a schematic configuration of an injection molding device.

FIG. 2 is a cross-sectional view showing a schematic configuration of a material supply device.

FIG. 3 is a perspective view showing a schematic configuration of a flat screw.

FIG. 4 is a schematic plan view of a barrel.

FIG. 5 is a perspective view of a molding die.

FIG. 6 is a cross-sectional view of the molding die.

FIG. 7 is a step diagram showing a runner removing method.

FIG. 8 is an explanatory diagram showing a state of molding die opening of the molding die.

FIG. 9 is an explanatory diagram showing a state of molding die opening of the molding die.

FIG. 10 is a diagram showing a state in which a guide section and a removal hand are inserted into the molding die.

FIG. 11 is an explanatory diagram showing a configuration of a guide section.

FIG. 12 is a view showing a state in which the runner is removed and a molded article is released from the molding die.

FIG. 13 is an explanatory diagram showing a configuration of a guide section in a second embodiment.

FIG. 14 is an explanatory diagram showing a configuration of a guide section in a third embodiment.

FIG. 15 is an explanatory diagram showing a configuration of a guide section in a fourth embodiment.

FIG. 16 is an explanatory diagram showing a configuration of a guide section in a fifth embodiment.

### DESCRIPTION OF EMBODIMENTS

### A. FIRST EMBODIMENT

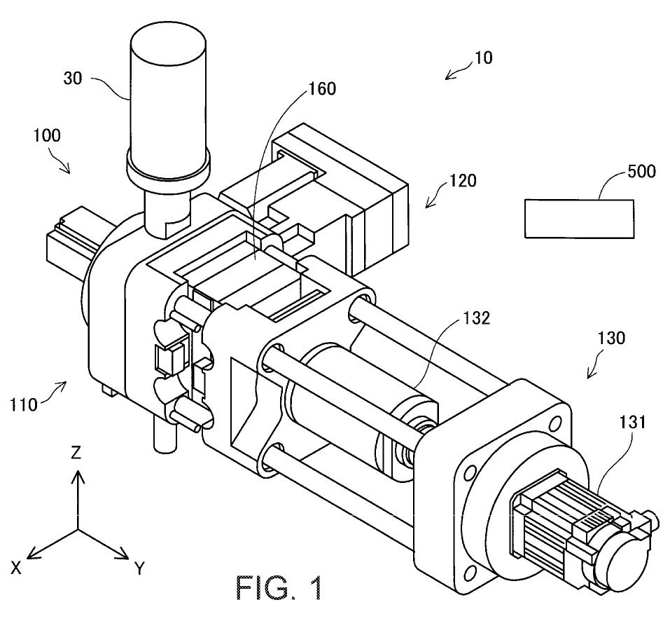

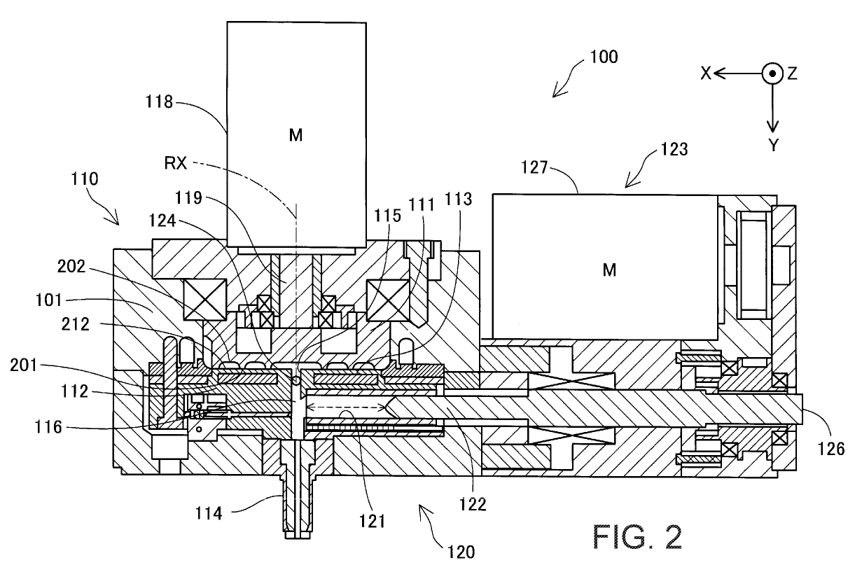

FIG. 1 is a perspective view showing a schematic configuration of an injection molding device 10. In FIG. 1, arrows indicating X, Y, and Z directions orthogonal to each other are shown. The X direction and the Y direction are directions parallel to a horizontal plane, and the Z direction is a direction along a vertical direction. The X, Y, and Z directions shown in FIG. 2 and subsequent figures correspond to the X, Y, and Z directions shown in FIG. 1. In the following description, when a direction is specified, a positive direction that is a direction indicated by an arrow is denoted by "+", a negative direction that is a direction opposite to the direction indicated by the arrow is denoted by "-", and positive and negative signs are used together for direction notation. A +Z direction is a vertically upward direction, and a -Z direction is a vertically downward direction. The vertically upward direction is a direction opposite to the vertically downward direction. The vertically downward direction is a direction in which gravity acts, and is also referred to as a gravity direction. Hereinafter, the vertically upward direction is simply referred to as upward, and the vertically downward direction is simply referred to as downward.

The injection molding device 10 includes a material supply device 100, a molding die clamping device 130, and a control section 500. The injection molding device 10 injects a plasticization material generated by the material supply device 100 into a molding die 160 to mold a molded article. Operations of the material supply device 100 and the molding die clamping device 130 are controlled by the control section 500. The control section 500 is configured as a computer including a CPU and a memory, and controls each section of the injection molding device 10 by the CPU executing a program stored in the memory. The control section 500 may be configured by a circuit.

The metal molding die 160 is mounted on the molding die clamping device 130. The molding die 160 is not limited to being made of metal, and may be made of resin or ceramic. The metal molding die 160 is referred to as a metal mold. Under control of the control section 500, the molding die clamping device 130 drives a molding die drive section 131 configured by a motor to rotate a ball screw 132 and opens and closes the molding die 160. Configuration of the molding die 160 will be described later.

A hopper 30 into which a material of a molded article is introduced is connected to the material supply device 100. As a material of the molded article, for example, a thermoplastic resin formed in a pellet shape is used. Examples of the thermoplastic resin include acrylonitrile butadiene styrene (ABS), polycarbonate (PC), polyoxymethylene (POM), polypropylene (PP), and polybutylene terephthalate (PBT). A material of the molded article may contain a metal or a ceramic in addition to a thermoplastic resin. The supply of a material to the material supply device 100 is not limited to the hopper 30, and may be performed via a tube through which a material is pressure-fed, for example.

The material supply device 100 plasticizes at least a part of the material supplied from the hopper 30 to generate a plasticization material, and injects the generated plasticization material into a cavity defined in the molding die 160. In the present specification, the term "plasticization" is a concept including melting, and means changing from a solid to a state having fluidity. Specifically, in a case of a material in which glass transition occurs, plasticization means that the temperature of a material is set to be equal to or higher than the glass transition point. In a case of a material in which glass transition does not occur, plasticization means that the temperature of a material is set to be equal to or higher than the melting point.

FIG. 2 is a cross-sectional view showing a schematic configuration of the material supply device 100. The material supply device 100 includes a plasticizing section 110 that plasticizes at least a part of a material to generate a plasticization material, a nozzle 114 that injects the plasticization material, and an injection section 120 that communicates with the nozzle 114.

The plasticizing section 110 includes a flat screw 111, a barrel 112, and a heater 113.

The flat screw 111 is accommodated in an accommodation section 101. The flat screw 111 is also referred to as a rotor or simply a screw. The flat screw 111 is rotated by a motor 118 in the accommodation section 101 around a drive shaft 119 of the motor 118. A central axis RX, which is a rotation center of the flat screw 111, coincides with a center of the drive shaft 119 of the motor 118 in an XZ plane. In the present embodiment, axial directions of the drive shaft 119 and the central axis RX are along the Y direction. Rotation of the flat screw 111 by the motor 118 is controlled by the control section 500. The flat screw 111 may be driven by the motor 118 via a decelerator.

A communication hole 115 is formed in a center of the barrel 112. The communication hole 115 communicates with a flow path 116. A cylinder 121 (to be described later) and a nozzle 114 are connected to the flow path 116. A check valve 124 is provided in the flow path 116 at a position upstream of the cylinder 121. The check valve 124 prevents backflow of plasticization material from the cylinder 121 toward the flat screw 111.

The heater 113 heats the barrel 112. Heating by the heater 113 is controlled by the control section 500.

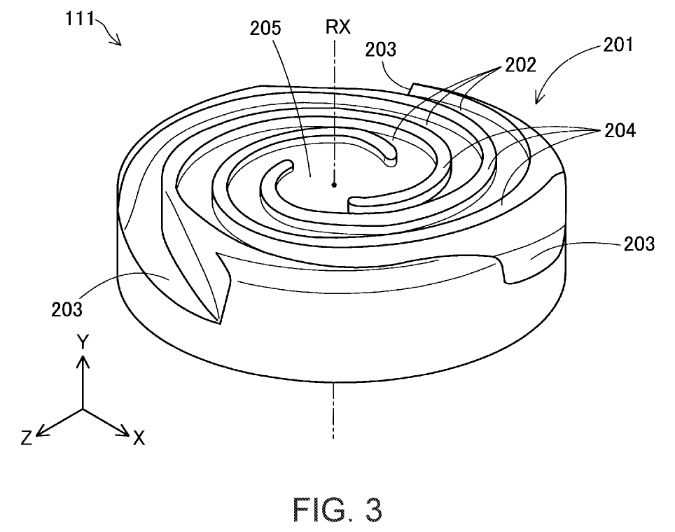

FIG. 3 is a perspective view showing a schematic configuration of the flat screw 111. The flat screw 111 has a substantially columnar shape in which the length in a direction along the central axis RX is smaller than the length in a direction perpendicular to the central axis RX. Spiral grooves 202 are formed around a central section 205 on a groove forming surface 201 of the flat screw 111 facing the barrel 112. The grooves 202 communicate with material introduction ports 203 formed on a side surface of the flat screw 111. A material supplied from the hopper 30 is supplied to the groove 202 through the material introduction port 203. The grooves 202 are formed by being separated from each other by ridge sections 204. FIG. 3 shows an example in which three grooves 202 are formed, but the number of grooves 202 may be one, two, or more. The grooves 202 are not limited to a spiral shape, may be helical or involute curve shape, and may extend so as to draw an arc from the central section 205 to the outer periphery.

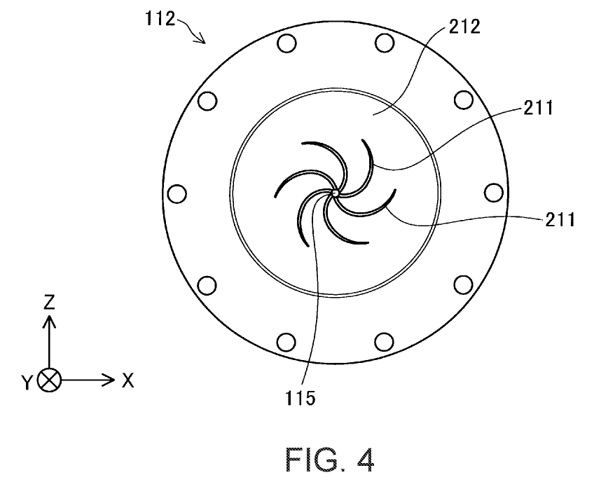

FIG. 4 is a schematic plan view of the barrel 112. The barrel 112 includes a facing surface 212 that faces the groove forming surface 201 of the flat screw 111. The communication hole 115, which communicates with the flow path 116, is formed at a center of the facing surface 212. A plurality of guide grooves 211 that are connected to the communication hole 115 and that extend in a spiral shape from the communication hole 115 toward the outer periphery are formed in the facing surface 212. The barrel 112 may not be provided with the guide groove 211. The guide groove 211 may not be connected to the communication hole 115.

The material supplied to the grooves 202 of the flat screw 111 flows along the grooves 202 and the guide grooves 211 by rotation of the flat screw 111 while being plasticized between the flat screw 111 and the barrel 112 by rotation of the flat screw 111 and heating of the heater 113, and is guided to the central section 205 of the flat screw 111. The material flowing into the central section 205 flows out to the flow path 116 from the communication hole 115 provided at a center of the barrel 112.

As shown in FIG. 2, the injection section 120 includes the cylinder 121 that communicates with the nozzle 114 and that is connected to the flow path 116 through which a plasticization material flows, a plunger 122 that moves in the cylinder 121, and a plunger drive section 123. The cylinder 121 has a substantially cylindrical shape. The cylinder 121 is also referred to as a sleeve. The plunger 122 has a substantially columnar shape. The plunger drive section 123 includes a ball screw 126 that moves the plunger 122 along a longitudinal direction of the plunger 122, and a motor 127 that drives the ball screw 126. When the ball screw 126 is driven by the motor 127, the plunger 122 connected to the ball screw 126 moves forward or backward. The term "forward" refers to a direction in which the plunger 122 approaches the flow path 116. The term "backward" refers to a direction in which the plunger 122 moves away from the flow path 116.

In the injection section 120, a suction operation and a feeding operation are executed by the plunger drive section 123 being controlled by the control section 500. The suction operation is an operation of sucking plasticization material from the flow path 116 into the cylinder 121 by moving the plunger 122 backward. The feeding operation is an operation of feeding plasticization material sucked into the cylinder 121 to the nozzle 114 by moving the plunger 122 forward. The control section 500 adjusts a movement amount and a movement speed of the plunger 122 in the suction operation and the feeding operation, thereby controlling an injection amount, an injection speed, and an injection pressure of a plasticization material from the nozzle 114. The suction operation is also referred to as a measurement operation.

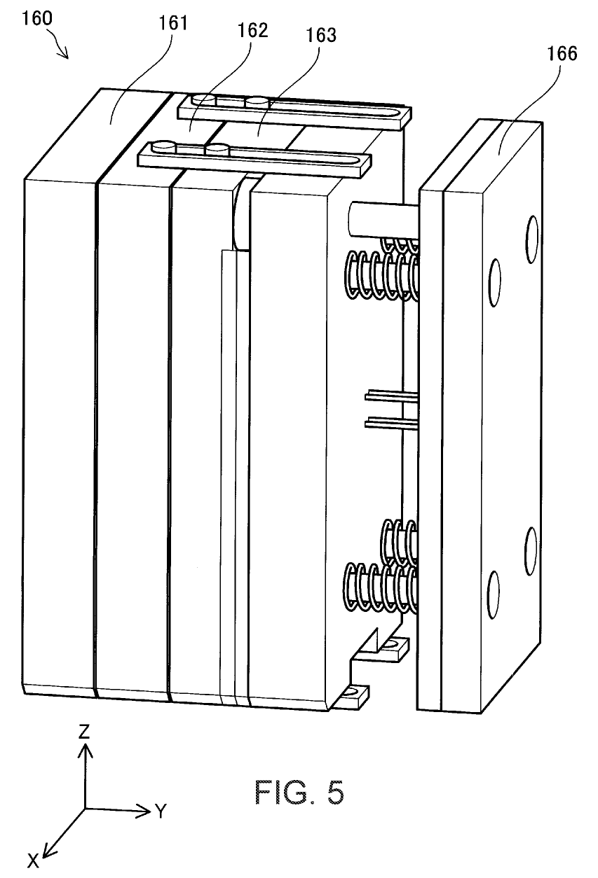

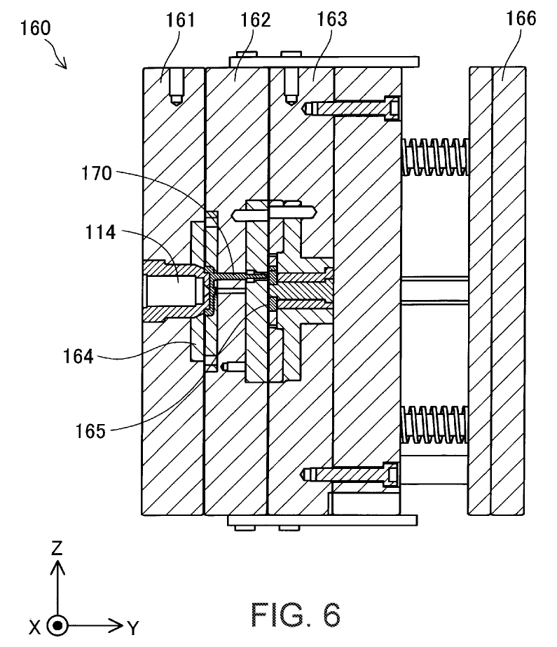

FIG. 5 is a perspective view of the molding die 160. FIG. 6 is a cross-sectional view of the molding die 160. FIGS. 5 and 6 show the molding die 160 in a closed state. The molding die 160 includes a first plate 161, a second plate 162, and a third plate 163. That is, the molding die 160 of the present embodiment is configured as a molding die including a three plate structure. The first plate 161 includes a stripper plate 164 for discharging a runner 170. The second plate 162 is also referred to as a fixed side molding die plate and corresponds to a fixed molding die. The third plate 163 is also referred to as a movable-side molding die plate and corresponds to a movable molding die. A cavity 165 in which a molded article is molded is defined between the second plate 162 and the third plate 163. The first plate 161 is attached to the material supply device 100. The second plate 162 and the third plate 163 are attached to the molding die clamping device 130 via a movable-side attachment plate 166. The second plate 162 and the third plate 163 are movable by the molding die clamping device 130 in a molding die clamping direction and a molding die opening direction with respect to the first plate 161. In the present embodiment, the molding die clamping direction is a -Y direction, and the molding die opening direction is a +Y direction.

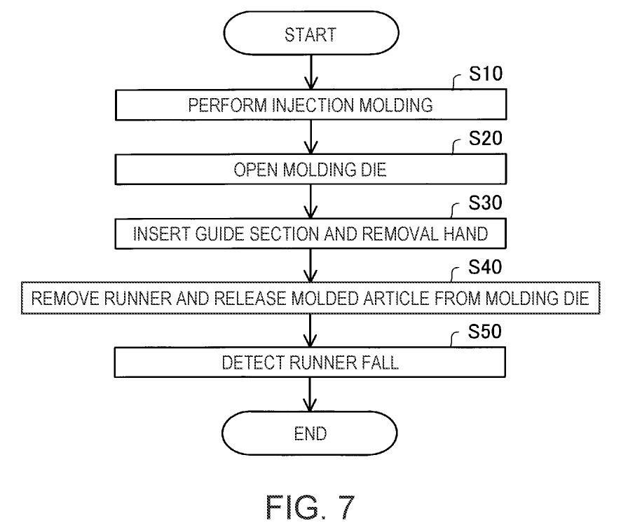

FIG. 7 is a step diagram showing a method for removing the runner 170. In step S10, the control section 500 controls the plasticizing section 110 and the injection section 120 to perform injection molding in a state where the molding die 160 is closed, that is, in a state where the molding die 160 is as shown in FIGS. 5 and 6. That is, the control section 500 injects the plasticization material into the cavity 165 of the molding die 160 from the nozzle 114 to mold a molded article.

In step S20, the control section 500 opens the molding die 160.

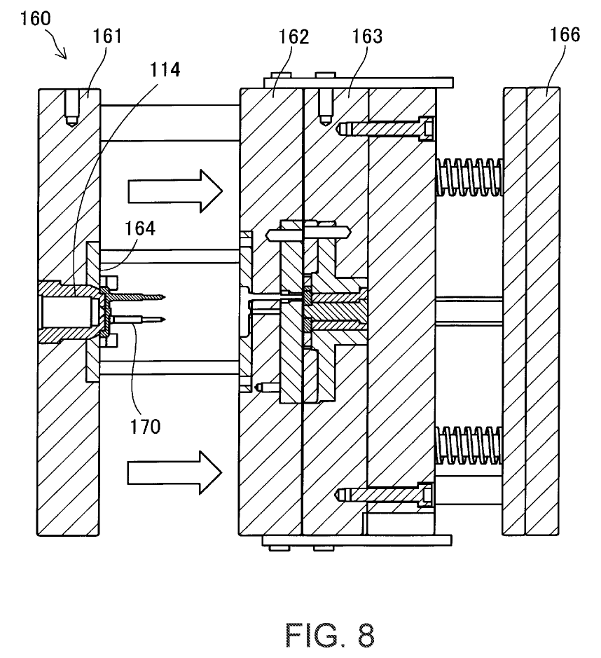

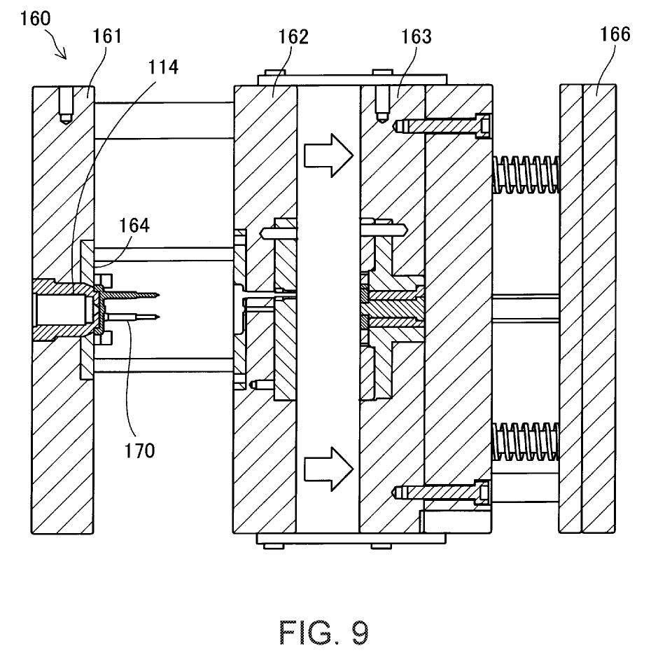

FIGS. 8 and 9 are explanatory diagrams showing a state of molding die opening of the molding die 160. The control section 500 controls the molding die clamping device 130 to, as shown in FIG. 8, separate the second plate 162 and the third plate 163 of the molding die 160 from the first plate 161. When the second plate 162 and the third plate 163 are separated from the first plate 161, the runner 170 and the molded article are separated from each other, and the runner 170 remains attached to the first plate 161. The runner 170 attached to the first plate 161 includes the runner 170 being attached to the nozzle 114 in the first plate 161 and to the stripper plate 164 provided on the first plate 161. In the present embodiment, the runner 170 is attached to both a tip end section of the nozzle 114 arranged in the first plate 161 and to the stripper plate 164. Subsequently, the control section 500 controls the molding die clamping device 130 to separate the third plate 163 from the second plate 162 as shown in FIG. 9.

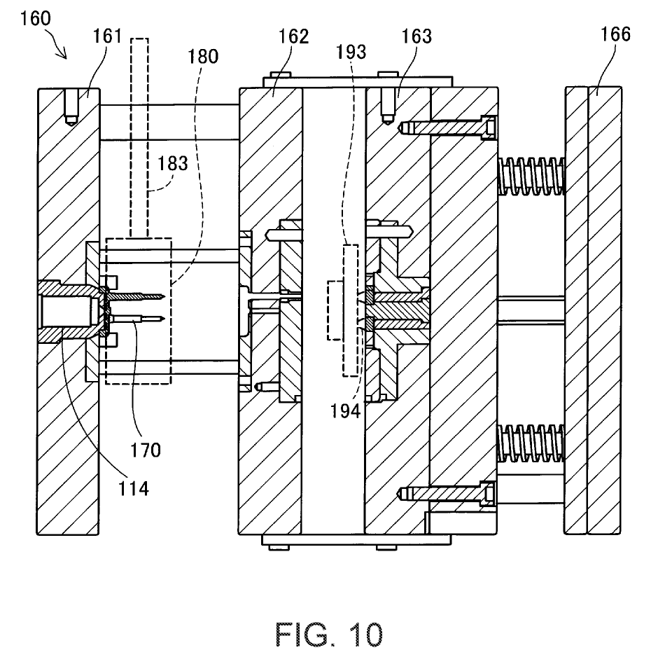

FIG. 10 is a diagram showing a state in which the guide section 180 and the removal hand 193 are inserted into the molding die 160. In step S30 of FIG. 7, the control section 500 inserts the guide section 180 and the removal hand 193 provided in the injection molding device 10 into the molding die 160 as shown in FIG. 10.

The guide section 180 is a member that guides a discharge direction of the runner 170. The removal hand 193 is a device that attracts and removes the molded article. The control section 500 inserts the guide section 180 between the first plate 161 and the second plate 162 that are separated apart. The control section 500 inserts the removal hand 193 between the second plate 162 and the third plate 163 that are spaced apart, and causes an attraction section 194 provided on the removal hand 193 to attract the molded article in the cavity 165. The removal hand 193 is configured as an attraction hand attached to an arm tip end of a robot (not shown).

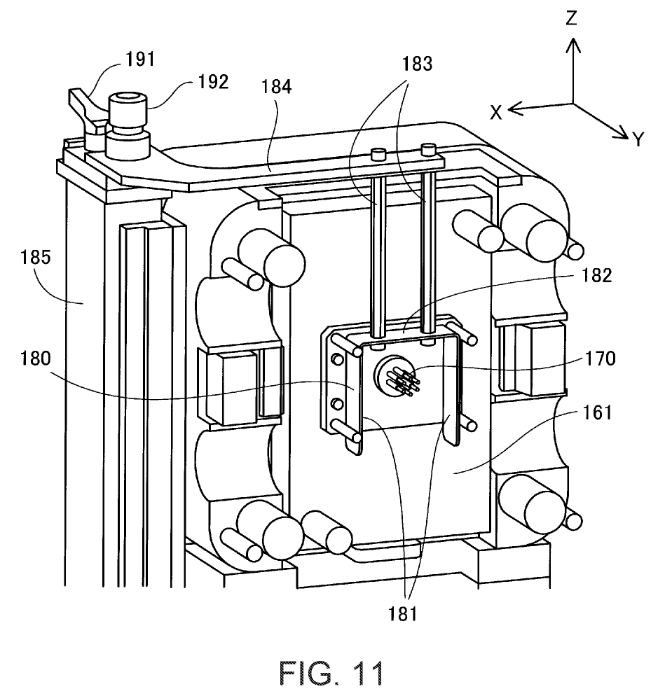

FIG. 11 is an explanatory diagram showing a configuration of the guide section 180. The guide section 180 includes a pair of wall sections 181. In the present embodiment, the pair of wall sections 181 face each other in the X direction. Upper sections of the pair of wall sections 181 are connected by a connection wall section 182. That is, the guide section 180 has a U-shape with an open lower portion. In the present embodiment, a surface of the guide section 180 on a second plate 162 side is open, but a wall surface may be arranged on the surface of the guide section 180 on the second plate 162 side. A pair of connection members 183 extending in the vertical direction are connected to the connection wall section 182. The pair of connection members 183 are connected to a tip end section of an arm section 184 extending in a horizontal direction. A base end section of the arm section 184 is connected to a guide drive section 185. The guide drive section 185 is configured by a linear actuator. In the present embodiment, the arm section 184 is connected to the guide drive section 185 using an attachment and detachment mechanism 192. The attachment and detachment mechanism 192 in the present embodiment includes a clamp structure that allows the arm section 184 to be attached to and detached from the guide drive section 185 only by operating a lever 191 without using a tool. In step S30 of FIG. 7, the control section 500 controls the guide drive section 185 to move the guide section 180 from upward to downward. Therefore, the guide section 180 is inserted between the first plate 161 and the second plate 162 from upward to downward. When the guide section 180 is inserted between the first plate 161 and the second plate 162, the runner 170 attached to the first plate 161 is positioned between the pair of wall sections 181.

In step S40 of FIG. 7, the control section 500 removes the runner 170 and releases the molded article from the molding die 160.

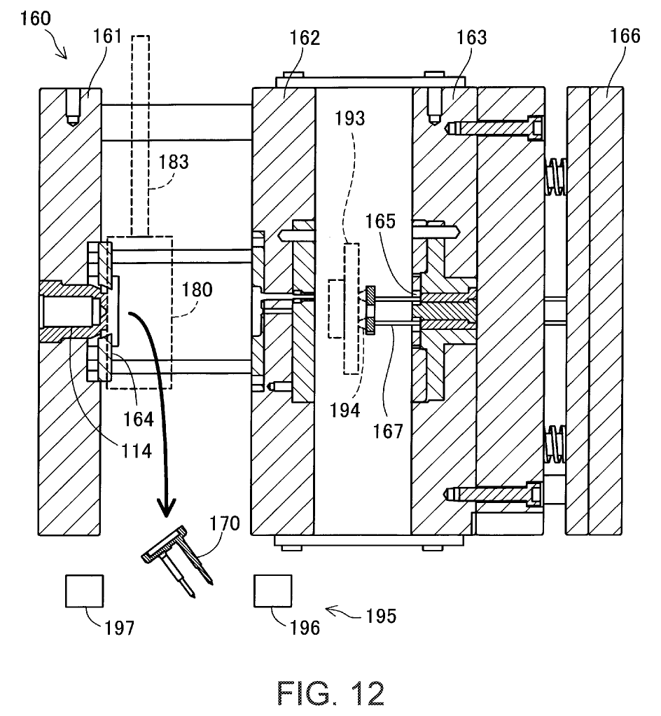

FIG. 12 is an explanatory diagram showing a state in which the runner 170 is removed and the molded article is released from the molding die 160. When the control section 500 further moves the third plate 163 in the molding die opening direction from the state shown in FIG. 10, an ejector pin 167 relatively protrudes from the third plate 163, and the molded article is released from the cavity 165. The released molded article is transported to outside of the molding die 160 by the removal hand 193. When the control section 500 controls the molding die clamping device 130 to further move the third plate 163 in the molding die opening direction, the stripper plate 164 provided on the first plate 161 is displaced in the molding die opening direction in conjunction with the movement of the third plate 163. When the stripper plate 164 is displaced in the molding die opening direction, the runner 170 attached to the first plate 161 is detached from the molding die 160 and falls downward while being guided by the guide section 180. In the present embodiment, a reverse tapered portion is formed around a tip end section of the nozzle 114, and the runner 170 bites into the reverse tapered portion, so that the runner 170 is kept attached to the vicinity of the tip end section of the nozzle 114 when the molding die 160 is opened. When the stripper plate 164 moves in the molding die opening direction, the runner 170 is disengaged from the reverse tapered portion of the tip end section of the nozzle 114, and the runner 170 is detached from the first plate 161.

In step S50 of FIG. 7, the control section 500 detects whether or not the detached runner 170 has fallen downward using a sensor 195 connected to the control section 500. As shown in FIG. 12, the sensor 195 in the present embodiment is an optical sensor including a light emitting section 197 and a light receiving section 196. When the runner 170 passes between the light receiving section 196 and the light emitting section 197, a signal indicating that the runner 170 has fallen is transmitted from the sensor 195 to the control section 500. The control section 500 detects whether or not the detached runner 170 has fallen depending on whether or not the signal has been received. For example, when the control section 500 determines that the detached runner 170 has not fallen after the stripper plate 164 is operated, the control section 500 stops the operation of the injection molding device 10. This prevents the molding die 160 from being driven in a state where the runner 170 is caught between the first plate 161 and the second plate 162.

According to the injection molding device 10 of the first embodiment described above, when the stripper plate 164 is to be operated to detach the runner 170 from the molding die 160, the guide section 180 is inserted between the first plate 161 and the second plate 162. Therefore, by dropping the runner 170 along the guide section 180, the runner 170 can be easily detached from the molding die 160 without gripping the runner 170 using a chuck or the like. In the present embodiment, since the runner 170 is surrounded by the guide section 180, it is possible to suppress the runner 170 from scattering in an unintended direction other than a downward direction. As a result, for example, the runner 170 can be suppressed from being caught in various shafts extending between the first plate 161 and the second plate 162, and thus, it is possible to suppress injection leakage or a problem in the molding die 160 from occurring due to the runner 170 being sandwiched between the first plate 161 and the second plate 162.

In the present embodiment, a lower portion of the guide section 180 is opened, and the guide section 180 is inserted into the molding die 160 from an upper side to a lower side. Therefore, the runner 170 is easily discharged from the molding die 160 by own weight of the runner 170. By this, for example, by arranging the collection container below the injection molding device 10, the runner 170 can be efficiently collected.

In the present embodiment, the sensor 195 can detect the fall of the runner 170. Therefore, when the runner 170 is not discharged from the molding die 160, the operation of the injection molding device 10 can be stopped. As a result, it is possible to suppress the occurrence of injection leakage and the occurrence of a problem in the molding die 160 due to the injection molding device 10 being driven in a state where the runner 170 remains in the molding die 160.

In the present embodiment, the guide section 180 is detachably attached to the guide drive section 185. Therefore, since the guide section 180 can be easily attached and detached, the removal of the molding die 160 and maintenance of the molding die 160 can be easily performed from above the injection molding device 10.

### B. SECOND EMBODIMENT

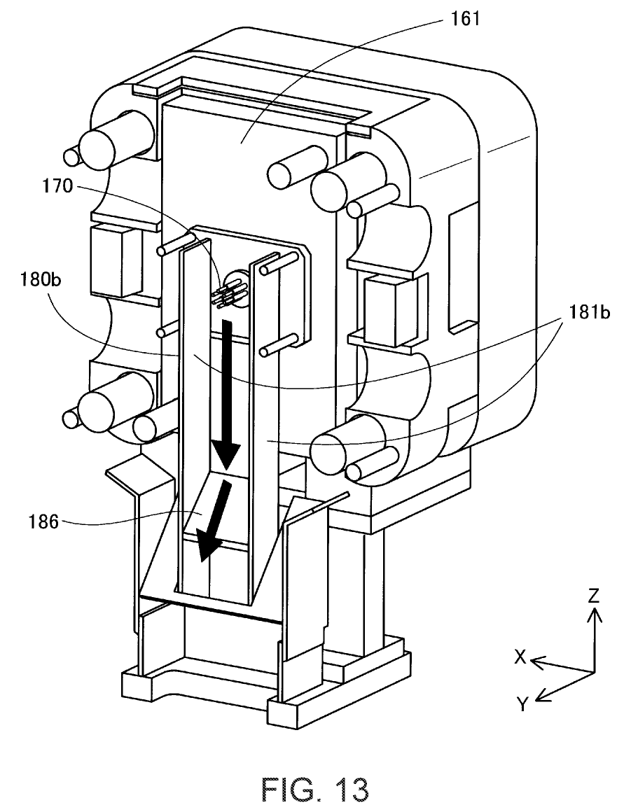

FIG. 13 is an explanatory diagram showing a configuration of a guide section 180b in a second embodiment. In the first embodiment, the guide section 180 has a shape with an open lower portion, and is inserted into the molding die 160 from above to below. In contrast, in the second embodiment, the guide section 180b has a shape in which an upper portion is opened, although the guide section 180b includes a pair of wall sections 181b, similarly to the first embodiment. In the second embodiment, in step S30 of FIG. 7, the guide section 180b is inserted into the molding die 160 from a lower side toward an upper side. In the example shown in FIG. 13, an inclined surface 186 is provided below the guide section 180b, and the runner 170 that has fallen down slides down the inclined surface 186 after falling down along the guide section 180b. The other configurations of the injection molding device 10 in the second embodiment are the same as those in the first embodiment.

In the second embodiment described above, since it is not necessary to arrange the arm section 184 and the guide section 180 above the molding die 160, it is possible to easily perform the removal of the molding die 160 and maintenance of the molding die 160.

### C. THIRD EMBODIMENT

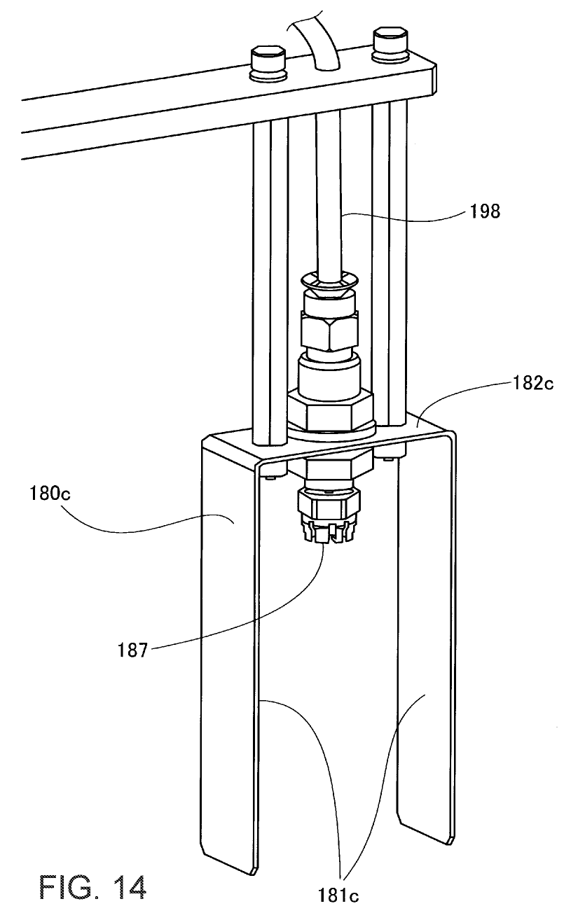

FIG. 14 is an explanatory diagram showing a configuration of a guide section 180c in a third embodiment. The guide section 180c of the third embodiment includes a spray port 187 that sprays gas toward the runner 170. Specifically, similarly to the first embodiment, the guide section 180c includes a pair of wall sections 181c, and the pair of wall sections 181c are connected by a connection wall section 182c. In the third embodiment, a spray port 187 is provided on the connection wall section 182c. In the present embodiment, compressed air supplied from the outside via an air tube 198 is jetted from the spray port 187. In step S40 of FIG. 7, the control section 500 operates the stripper plate 164 to detach the runner 170, and at the same time or immediately thereafter, controls the spray port 187 to jet gas from the spray port 187. The other configurations of the injection molding device 10 in the third embodiment are the same as those in the first embodiment.

According to the third embodiment described above, since the runner 170 can be discharged by jetting gas toward the runner 170, it is possible to suppress the runner 170 from being caught in a bridge shape between the first plate 161 and the second plate 162.

### D. FOURTH EMBODIMENT

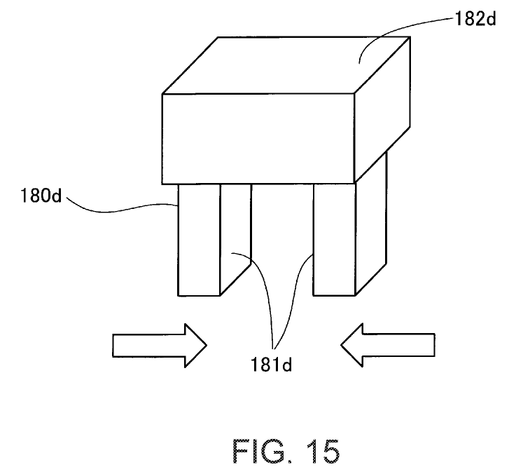

FIG. 15 is an explanatory diagram showing a configuration of a guide section 180d in a fourth embodiment. Similarly to the first embodiment, the guide section 180d of the fourth embodiment includes a pair of wall sections 181d and a connection wall section 182d. In the fourth embodiment, the guide section 180d includes an adjustment mechanism capable of adjusting an interval between the pair of wall sections 181d. More specifically, in the fourth embodiment, the pair of wall sections 181d are configured to be movable relative to the connection wall section 182d. The connection wall section 182d is provided with an actuator for moving the pair of wall sections 181d. As such an adjustment mechanism, for example, an air chuck can be used. In step S30 of FIG. 7, the control section 500 adjusts an interval between the pair of wall sections 181d after inserting the guide section 180 between the first plate 161 and the second plate 162. For example, the control section 500 adjusts the interval between the pair of wall sections 181d so that the interval is slightly larger than the width of the runner 170. The interval after adjustment is designated by a user in advance. Note that the adjustment of the interval between the wall sections 181d may be performed automatically by the control section 500, for example, by providing a distance sensor on the pair of wall sections 181d and measuring the distance between the runner 170 and the pair of wall sections 181d using the distance sensor. The other configurations of the injection molding device 10 in the fourth embodiment are the same as those in the first embodiment.

According to the fourth embodiment described above, a movement range of the detached runner 170 can be limited by adjusting the interval between the pair of wall sections 181d provided on the guide section 180d. Therefore, the runner 170 can be suppressed from scattering in an unintended direction.

### E. FIFTH EMBODIMENT

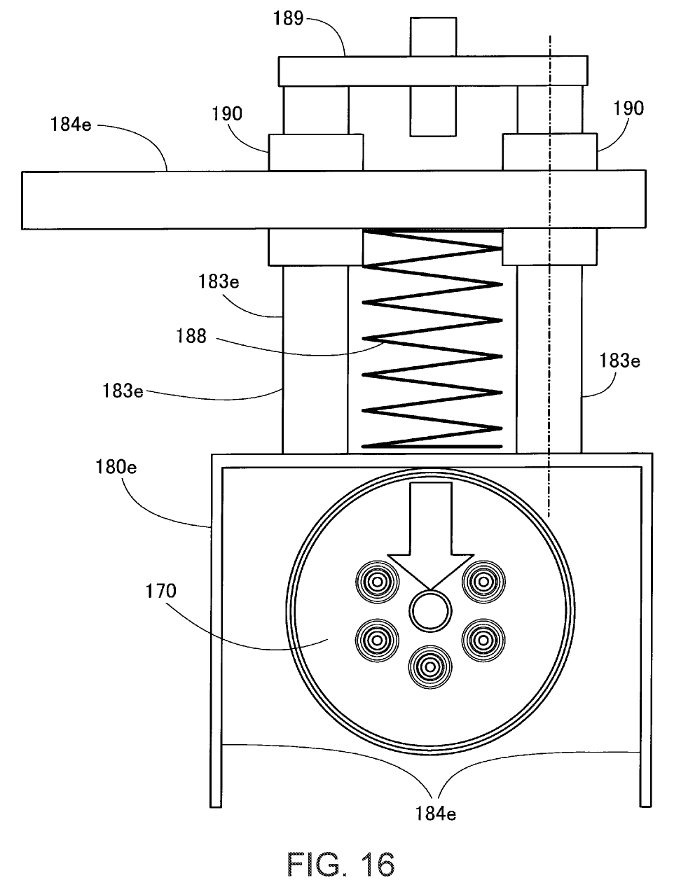

FIG. 16 is an explanatory diagram showing a configuration of a guide section 180e in a fifth embodiment. The guide section 180e of the fifth embodiment includes a pair of wall sections 181e and a connection wall section 182e. In the fifth embodiment, a spring 188 serving as an elastic body is arranged between the connection wall section 182e and an arm section 184e of the guide section 180e. A pair of connection members 183e are inserted into through holes formed in the arm section 184e via bushing 190, and are movable in a vertical direction. Upper ends of the pair of connection members 183e are connected to each other by a retaining member 189 on an opposite side of the spring 188. The spring 188, the connection members 183e, the arm section 184e, and the retaining member 189 constitute an elastic mechanism that elastically brings the guide section 180 into contact with the runner 170. In step S30 of FIG. 7, the control section 500 controls the guide drive section 185 to move the guide section 180 downward, and brings a lower surface of the connection wall section 182 of the guide section 180 into contact with the runner 170. The guide section 180 elastically contacts the runner 170 by the action of the elastic mechanism described above. In a state in which the guide section 180 is elastically in contact with the runner 170, the control section 500 operates the stripper plate 164 in step S40. The other configurations of the injection molding device 10 in the fifth embodiment are the same as those in the first embodiment.

According to the fifth embodiment described above, the stripper plate 164 is operated after the guide section 180 is elastically brought into contact with the runner 170 from above, and thus the runner 170 can be reliably detached downward. Therefore, the runner 170 can be suppressed from scattering in an unintended direction.

### F. OTHER EMBODIMENTS

(F1) The above-described embodiments can be arbitrarily combined. For example, two or more of the spray port 187 in the third embodiment, the pair of movable wall sections 181d in the fourth embodiment, and the elastic mechanism in the fifth embodiment can be appropriately combined.

(F2) In the above-described embodiment, the injection molding device 10 includes the flat screw 111 as a screw. In contrast, the injection molding device 10 may include an in-line screw as a screw.

(F3) In the above-described embodiment, in step S50 shown in FIG. 7, whether or not the runner 170 has fallen is detected using the sensor 195. On the other hand, the process of step S50 may be omitted.

(F4) In the above-described embodiment, the guide section 180 is detachably connected to the guide drive section 185 using the attachment and detachment mechanism 192. In contrast, the guide section 180 may be fixed to the guide drive section 185 by a bolt or the like.

(F5) In the first embodiment, the guide section 180 is inserted into the molding die 160 from above downward. In contrast, the guide section 180 may be inserted into the molding die 160 from the horizontal direction. A discharge direction of the runner 170 is not limited to a downward direction. For example, the runner 170 can be discharged in the horizontal direction by directing the spray port 187 in the third embodiment in the horizontal direction.

### G. Other aspects

The present disclosure is not limited to the above-described embodiments, and can be realized in various configurations without departing from the spirit thereof. For example, the technical features of the embodiments corresponding to the technical features in each aspect described below can be appropriately replaced or combined in order to solve a part or all of the problems described above or to achieve a part or all of the effects described above. Unless the technical features are described as essential in the present specification, the technical features can be appropriately deleted.

(1) According to a first aspect of the present disclosure, a runner removing method of removing a runner in a molding die that includes a first plate including a stripper plate, a second plate, and a third plate and in which a cavity is defined between the second plate and the third plate is provided.

The runner removing method includes (A) a step of, after a molded article is molded in the cavity in a state where the first plate, the second plate, and the third plate are closed, separating the second plate and the third plate from the first plate in a state where the runner is attached to the first plate; (B) a step of inserting, between the first plate and the second plate that are spaced apart, a guide section including a pair of wall sections, and of positioning the runner between the pair of wall sections; and (C) a step of, in a state where the runner is positioned between the pair of wall sections, operating the stripper plate to detach the runner from the molding die.

According to such an aspect, when the stripper plate is operated to detach the runner from the molding die, the guide section is inserted between the first plate and the second plate. Therefore, by discharging the runner along the guide section, the runner can be easily detached from the molding die without gripping the runner using a chuck or the like.

(2) The above-described aspect may be configured such that the guide section is open on a vertically downward direction and in step (B), the guide section is inserted in a vertically downward direction from a vertically upward direction that is a direction opposite to the vertically downward direction.

According to such an aspect, the runner is easily discharged from the molding die by own weight of the runner.

(3) The above-described aspect may be configured such that the runner removing method further includes a step of detecting whether or not the detached runner has fallen in the vertically downward direction using a sensor.

According to such an aspect, for example, when the runner is not discharged, the operation of the injection molding device can be stopped.

(4) The above-described aspect may be configured such that the guide section includes an spray port that sprays gas toward the runner and step (C) includes a step of spraying the gas from the spray port.

According to such an aspect, by injecting gas toward the runner, it is possible to suppress the runner from being caught in a bridge shape between the first plate and the second plate.

(5) The above-described aspect may be configured such that the guide section includes an adjustment mechanism configured to adjust an interval between the pair of wall sections and step (B) includes a step of adjusting the interval between the pair of wall sections using the adjustment mechanism.

According to such an aspect, by adjusting the interval between the pair of wall sections provided in the guide section, it is possible to suppress the runner from scattering in an unintended direction.

(6) The above-described aspect may be configured such that the guide section includes an elastic mechanism that elastically brings the guide section into contact with the runner and step (B) includes a step of bringing the guide section into elastic contact with the runner by the elastic mechanism.

According to such an aspect, by bringing the guide section into elastic contact with the runner, it is possible to suppress the runner from scattering in an unintended direction when the stripper plate is operated.

(7) The above-described aspect may be configured such that the guide section is configured to be attached to and detached from a guide drive section that drives the guide section, using an attachment and detachment mechanism.

According to such an aspect, since the guide section can be easily attached and detached, the removal of the molding die and maintenance of the molding die can be easily performed.

(8) According to a second aspect of the present disclosure, an injection molding device is provided.

The injection molding device includes a molding die clamping device to which a molding die that includes a first plate including a stripper plate, a second plate, and a third plate and in which a cavity is defined between the second plate and the third plate is mounted; a guide section including a pair of wall sections; and a control section that controls operations of the molding die and the guide section, wherein after a molded article is molded in the cavity in a state where the first plate, the second plate, and the third plate are closed, the control section separates the second plate and the third plate from the first plate in a state where a runner is attached to the first plate, inserts the guide section between the first plate and the second plate that are spaced apart, positions the runner between the pair of wall sections, and, in a state where the runner is positioned between the pair of wall sections, operates the stripper plate to detach the runner from the molding die.

What is claimed is:

1. A runner removing method in a molding die that includes a first plate including a stripper plate, a second plate, and a third plate and in which a cavity is defined between the second plate and the third plate, the runner removing method comprising:
(A) a step of, after a molded article is molded in the cavity in a state where the first plate, the second plate, and the third plate are closed, separating the second plate and the third plate from the first plate in a state where the runner is attached to the first plate;
(B) a step of inserting, between the first plate and the second plate that are spaced apart, a guide section including a pair of wall sections, and of positioning the runner between the pair of wall sections; and
(C) a step of, in a state where the runner is positioned between the pair of wall sections, operating the stripper plate to detach the runner from the molding die.

2. The runner removing method according to claim 1, wherein
the guide section is open on a vertically downward direction and
in step (B), the guide section is inserted in a vertically downward direction from a vertically upward direction that is a direction opposite to the vertically downward direction.

3. The runner removing method according to claim 2, further comprising:
a step of detecting whether or not the detached runner has fallen in the vertically downward direction using a sensor.

4. The runner removing method according to claim 1, wherein
the guide section includes a spray port that sprays gas toward the runner and
step (C) includes a step of spraying the gas from the spray port.

5. The runner removing method according to claim 1, wherein
the guide section includes an adjustment mechanism configured to adjust an interval between the pair of wall sections and
step (B) includes a step of adjusting the interval between the pair of wall sections using the adjustment mechanism.

6. The runner removing method according to claim 1, wherein
the guide section includes an elastic mechanism that elastically brings the guide section into contact with the runner and
step (B) includes a step of bringing the guide section into elastic contact with the runner by the elastic mechanism.

7. The runner removing method according to claim 1, wherein
the guide section is configured to be attached to and detached from a guide drive section that drives the guide section, using an attachment and detachment mechanism.

8. An injection molding device comprising:
a molding die clamping device to which a molding die that includes a first plate including a stripper plate, a second plate, and a third plate and in which a cavity is defined between the second plate and the third plate is mounted;
a guide section including a pair of wall sections; and
a control section that controls operations of the molding die and the guide section, wherein
after a molded article is molded in the cavity in a state where the first plate, the second plate, and the third plate are closed, the control section separates the second plate and the third plate from the first plate in a state where a runner is attached to the first plate, inserts the guide section between the first plate and the second plate that are spaced apart, positions the runner between the pair of wall sections, and, in a state where the runner is positioned between the pair of wall sections, operates the stripper plate to detach the runner from the molding die.
